(19) United States
(12) Patent Application Publication
(10) Pub. No.: US 2019/0197457 A1
(43) Pub. Date: Jun. 27, 2019

(54) ASSIGNING TICKETS TO AGENTS BASED ON RELEVANT SKILLS IN A CUSTOMER-SUPPORT TICKETING SYSTEM

(71) Applicant: Zendesk, Inc., San Francisco, CA (US)

(72) Inventors: Louis J. Chan, Belmont, CA (US); Joshua Y. Lam, Berkeley, CA (US); Craig A. Little, San Francisco, CA (US); Austin Wang, San Francisco, CA (US); Michael Erik Smedberg, Oakland, CA (US); Kristen L. Mirenda, San Francisco, CA (US)

(73) Assignee: Zendesk, Inc., San Francisco, CA (US)

(21) Appl. No.: 15/850,240

(22) Filed: Dec. 21, 2017

(51) Int. Cl. G06Q 10/06; G06Q 30/00

(52) U.S. Cl. CPC G06Q 10/063112; G06Q 30/016

(57) ABSTRACT

During operation, the system obtains a set of tickets to be processed at the customer-support ticketing system, wherein each ticket is tagged with any required skills, which are required to respond to the ticket. The system then enables an agent to request tickets to process, wherein a data structure representing the agent is tagged with any skills possessed by the agent. In response to the request, the system selects a matching subset of the set of tickets to be processed, wherein the matching subset comprises tickets for which the agent possesses a superset of the required skills that the ticket is tagged with. Next, the system presents the matching subset of tickets to the agent through a UI. Finally, the system enables the agent to operate the UI to: select a ticket from the matching subset of the set of tickets to be processed; and respond to an associated customer request.

### BACKGROUND

### Field

The disclosed embodiments generally relate to computer-based applications that help businesses manage customer-service interactions. More specifically, the disclosed embodiments relate to a technique for facilitating the assignment of tickets to agents based on relevant skills in a customer-support ticketing system.

### Related Art

As electronic commerce continues to proliferate, customers are beginning to use online customer-service resources to solve problems, or to obtain information related to various products or services. These online customer-service resources commonly include ticketing systems, product-related knowledge bases, and online chat systems that are designed to help customers resolve their problems, either by providing information to the customers, or by facilitating online interactions with customer-support agents. When designed properly, these online customer-service resources can automate customer-service interactions, thereby significantly reducing a company's customer-service costs.

A major challenge in designing customer-service ticketing systems is to match customers' tickets with specific agents who are best suited to resolve customers' problems. This is a challenging issue because different agents possess different skills, such as fluency in specific languages, and expertise with specific products. Existing approaches for assigning tickets to agents operate by assigning agents to groups associated with specific skills, such as “agents who are French speakers,” or “agents who have expertise about ski bindings” and then using ad hoc rules encoded in triggers to assign incoming tickets to specific groups of agents. However, this existing approach does not work efficiently in practice because agents typically possess a number of relevant skills, and it is cumbersome to form and manage groups of agents for each possible combination of relevant skills, such as agents who both speak French and have expertise about ski bindings.

Hence, what is needed is a customer-support ticketing system that assigns tickets to agents based on relevant skills without the drawbacks of the existing group-based ticket-assignment techniques.

### SUMMARY

The disclosed embodiments relate to a system that associates tickets with agents in a customer-support ticketing system. During operation, the system obtains a set of tickets to be processed at the customer-support ticketing system, wherein each ticket is tagged with any required skills, which are required to respond to the ticket. The system then enables an agent to request tickets to process, wherein a data structure representing the agent is tagged with any skills possessed by the agent. In response to the request, the system selects a matching subset of the set of tickets to be processed, wherein the matching subset comprises tickets for which the agent possesses a superset of the required skills that the ticket is tagged with. Next, the system presents the matching subset of tickets to the agent through a UI. Finally, the system enables the agent to operate the UI to: select a ticket from the matching subset of the set of tickets to be processed; and respond to an associated customer request.

In some embodiments, obtaining the set of tickets to be processed involves tagging each ticket in the set of tickets by: determining any required skills, which are required to respond to the ticket based on raw data from the ticket and one or more pre-defined rules that associate raw data with required skills; and tagging the ticket with the required skills, if any.

In some embodiments, the required skills for a ticket can include one or more of the following: a language of the customer request; a product or product line associated with the customer request; a time zone associated with the customer request; a level of technical skill required to respond to the customer request; a level of emotional intelligence required to respond to the customer request; a required agent tier for an agent who responds to the customer request; and a required security level for an agent who responds to the customer request.

In some embodiments, in additional to being tagged with any required skills, each ticket in the set of tickets to be processed can be tagged with desired skills that the method attempts to match with an associated agent's skills.

In some embodiments, presenting the matching subset of tickets to the agent includes presenting the matching subset of tickets to the agent based on how well the required skills of the tickets match the skills of the agent.

In some embodiments, the system allows the agent to add, modify or remove tags for one or more skills from the data structure representing the agent.

In some embodiments, the system allows the agent to add, modify or remove tags for one or more required skills from a ticket in the set of tickets to be processed.

The disclosed embodiments relate to another system that uses a push model to associate tickets with agents in the customer-support ticketing system. During operation of the push model, the system receives a ticket to be processed at the customer-support ticketing system, wherein the ticket is tagged with any required skills, which are required to respond to the ticket. Next, the system performs a matching operation to select an agent from a set of agents who are available to process tickets, wherein each available agent is represented by a data structure, which is tagged with any skills possessed by the agent, and wherein the matching operation selects an agent who possesses a superset of the required skills, if any, that the ticket is tagged with. The system then presents the ticket to be processed to the agent through a user interface (UI), and allows the agent to operate the UI to process the ticket by responding to an associated customer request

### BRIEF DESCRIPTION OF THE FIGURES

FIG. 1 illustrates a computing environment including an application and associated ticketing system in accordance with the disclosed embodiments.

FIG. 2 illustrates how a ticket is processed in accordance with the disclosed embodiments.

FIG. 3 illustrates the process for assigning tickets to agents under a pull model in accordance with the disclosed embodiments.

FIG. 4 illustrates the process for assigning tickets to agents under a push model in accordance with the disclosed embodiments.

FIGS. 5A and 5B present flow charts illustrating a process for assigning tickets to agents in a customer-support ticketing system under a pull model in accordance with the disclosed embodiments.

FIG. 5C presents a flow chart illustrating a process for associating tickets with agents in a customer-support ticketing system under the push model in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### System Configuration Example

The disclosed embodiments relate to a system that implements a “skills-based,” “attribute-based” or, more generally, a “set-based” approach to ticket routing. Suppose we are implementing a customer-support system for the Acme Corporation, which manufactures snow-ski-related equipment. Also assume that Acme has global reach, and supports multiple languages, including English, French, German, Spanish, Italian, Japanese, and Mandarin. Moreover, assume that we have agents that speak each of these languages, and some agents speak multiple languages.

Assume that Acme has multiple product lines, including skis, ski bindings, ski clothing, ski goggles, ski helmets, avalanche gear, parts, and accessories, and that most agents have expertise in at least one product line. Moreover, assume Acme has multiple support centers around the world. In general, we want support incidents to be handled by agents that are on the same continent as a customer. This helps us have agents available in the correct time zones, and also corresponds to local expertise of agents (e.g., agents in Australia might know about the best ski-service technicians in Sydney).

Finally, assume that Acme has three tiers of agents. Tier1 agents are the least sophisticated, tier2 agents are more sophisticated than tier1 agents, and tier3 agents are the most expert. Moreover, assume agents in a given tier are trusted to handle lower-tier questions (e.g., tier2 agents are trusted to handle tier1 and tier2 questions, but tier1 agents are not trusted to handle tier2 questions.)

Also assume that Acme sponsors professional skiers, and those professional skiers endorse Acme products, wherein each sponsored professional skier has an assigned support agent. For example, Cindy is a tier3 agent in Switzerland who is assigned to support skier A. Whenever skier A has a technical question, it is sent directly to Cindy. Occasionally, Cindy works with skier A to prepare for ski competitions.

Acme also sometimes works with a skier in a capacity that requires some secrecy. For example, the skier might be helping to develop a new type of competition ski suit that minimizes air friction, but the new ski suit has not been released for sale yet. The skier might be willing to work with Acme support agents to refine the new ski outfit, but they do not want the world to know about the new ski outfit until after the competition season completes. To ensure secrecy, Acme assigns tickets related to the new ski outfit to a special group of “trusted agents.” Agents who are not trusted should not be able to find out about these tickets, because they would be exposed to the secrets of the new ski outfit design.

By using the new “skills-based routing” feature, we can provide the same level of ticket responsiveness, but the system can be more easily configured than for a conventional group-based ticket routing process. Additionally, because it is simpler to configure, and automatically routes tickets to the most appropriate agent, service requests are handled more expeditiously. For example, by using the new skills-based routing approach, a German language service request in the United States can be routed to a German-speaking agent in any country without explicit configuration.

To facilitate skills-based routing, we specify a list of skill types and corresponding skills for each skill type. Note that these skill types are just “strings” in the sense that we can create any skill type that Acme wants, such as language, product line, etc. We create skill type objects for each of their skill types: language, product line, location, and tier. Next, for each skill type, we can add the relevant skills. For example, for tiers, we can specify that the allowed skills are “tier1,” “tier2,” and “tier3.”

Next, we can specify which skill types we want to use for routing. In our case, we want to use all of them. Hence, we want to route by language, product line, location, and tier.

For each agent, we then set their skills. For Cindy, we can set her language skills to [“English,” “French”], and we can set her product line skills to [“skis,” “ski bindings,” . . . ]. Note that we would probably set at least one skill from the four skill types for every agent, although some agents might be missing some skill types (e.g., some junior agents might not have a product expertise.)

Recall that we want tier3 agents to be able to handle tickets that are tier1 or tier2. This can be accomplished by adding all relevant tiers to each tier3 agent. Cindy is a tier3 agent, so her tier skills are set to [“tier1,” “tier2,” “tier3”]. This means that Cindy can handle tier1, tier2, and tier3 tickets. We can also implement a system where values for some skills types are marked as “hierarchical” and are ordered. For instance, the “tier” skill type could be marked as “hierarchical,” which would let the system know that every tier3 agent is automatically a tier2 agent and a tier1 agent. This means that the administrator would not need to mark each individual tier3 agent as also being a tier2 and a tier1 agent.

Note that for each skill, we can use a trigger to set that skill on the tickets. For example, we can create a trigger that checks if the language is French. If so, the trigger sets the language required skill for the ticket to “French.” Note that this particular trigger ONLY checks for French; it does not do anything about product line, tier, etc. We can also create a trigger that checks whether the ticket is about ski bindings. If so, the triggers sets the product line required skill to “ski bindings.”

After the system is configured as in the example above, the ticket-routing process can be performed. We describe this ticket-routing process in more detail below, but we first describe an exemplary computing environment that supports the ticket-routing process.

### Computing Environment

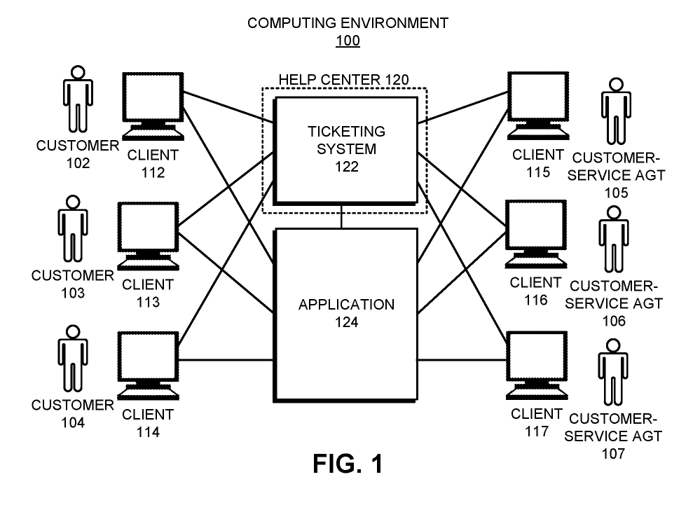

FIG. 1 illustrates an exemplary computing environment 100 including an application 124 and ticketing system 122 in accordance with the disclosed embodiments. Within computing environment 100, a number of customers 102-104 interact with an application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a help center 120 to obtain help in dealing with the problems or questions. For example, a user of accounting software may need help in using a feature of the accounting software, or a customer of a website that sells sporting equipment may need help in cancelling an order that was erroneously entered. This help may be provided by customer-service agents 105-107 who operate client computer systems 115-117, respectively, to interact with customers 102-104 through help center 120. Note that customer-service agents 105-107 can access application 124 (either directly or indirectly through help center 120) to help resolve an issue.

In some embodiments, help center 120 is not associated with computer-based application 124, but is instead associated with another type of product or service that is offered to a customer. For example, help center 120 can provide assistance with a product, such as a television, or with a service such as a package-delivery service.

Help center 120 organizes customer issues using a ticketing system 122, which generates tickets to represent each customer issue. Ticketing systems are typically associated with a physical or virtual “help center” (or “help desk”) for resolving customer problems.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent.

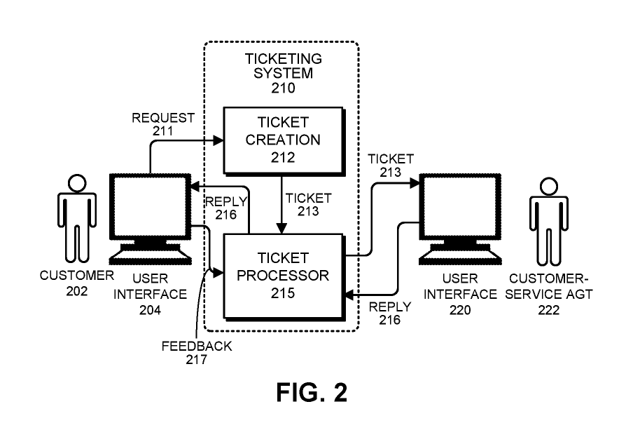

FIG. 2 illustrates additional details about how a ticket is processed in accordance with the disclosed embodiments. The process starts with a ticket-creation operation 212 that takes place within ticketing system 210 and creates a ticket 213. This ticket-creation operation is triggered by actions of a customer 202 who has an issue with a product or a service, and submits a request 211 to obtain help with the issue. Note that customer 202 can submit request 211 through a number of possible channels, including through email, online forms, social networking sites, etc. In response to request 211, the ticket-creation operation 212 produces a ticket 213 that feeds into a ticket processor 215.

Next, if the system is operating under a push model, ticket processor 215 selects a customer service agent 222 using a selection process (which is described in more detail below) and then presents ticket 213 to a selected customer service agent 222 through a user interface 220. In contrast, if the system is operating under a pull model, customer service agent 222 is presented with a list of tickets to be processed, and the customer service agent 222 then selects a ticket to process. Customer service agent 222 then processes the selected ticket by sending a reply 216 to respond to an associated customer request. Reply 216 flows back through ticket processor 215 and is presented to customer 202 through a user interface 204. (Note that user interface 204 can be implemented in a number of different ways for both mobile and desktop platforms. For example, user interface 204 can be incorporated into: a web page, an email, or a UI screen provided by an application. User interface 204 can also be part of a third party system.)

Next, after the issue has been resolved, customer 202 can provide feedback 217 about how well the issue was resolved. This feedback 217 can be propagated back to ticket processor 215, wherein the feedback 217 is used to improve subsequent customer interactions.

### Ticket Assignment Process

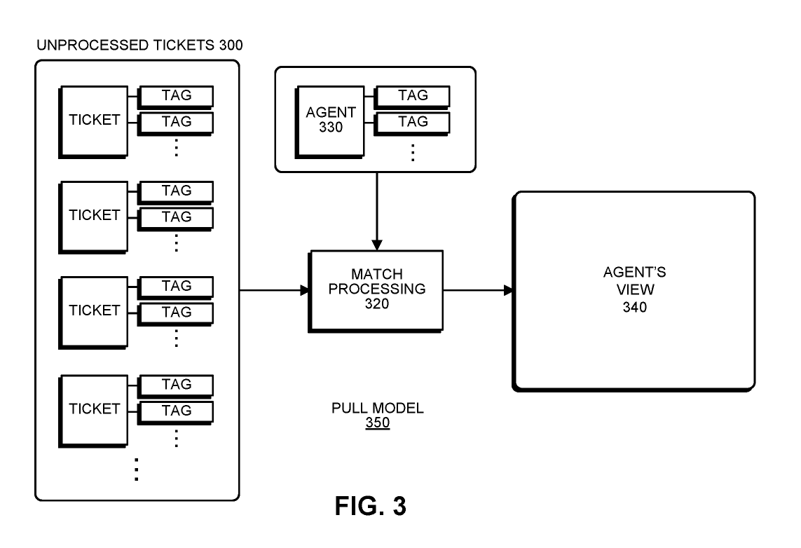

FIG. 3 illustrates the process for assigning tickets to agents under a pull model 350 in accordance with the disclosed embodiments. Before the process starts, the system possesses a set of unprocessed tickets 300, wherein each ticket comprises a ticket data structure, which is tagged with any required skills, which are required to respond to the ticket. Note that, in general, the system can use any type of data structure to represent the tickets and associated tags containing required skills, and also to represent the agent and associated tags containing agent skills. For example, the system can use objects within an object-oriented programming system to represent tickets and agents, wherein the associated tags comprise fields within the objects. In another example, the system can use rows in a relational database to represent tickets and agents, wherein the associated tags comprise fields within the rows, or the tags could be represented in rows of a special “tags” table.

The process starts when the system receives an indication that an agent is available to process tickets, wherein a data structure representing the agent 330 includes tags which specify skills of the agent. Next, the system performs a match processing operation 320 to select a matching subset of the set of tickets to be processed, wherein the matching subset comprises tickets for which the agent possesses a superset of the required skills that the ticket is tagged with. The system then presents the matching subset of tickets to the agent through an agent's view 340 in a user interface UI. The system then allows the agent to operate the UI to: select a ticket from the matching subset of the set of tickets to be processed; and process the selected ticket by responding to an associated customer request.

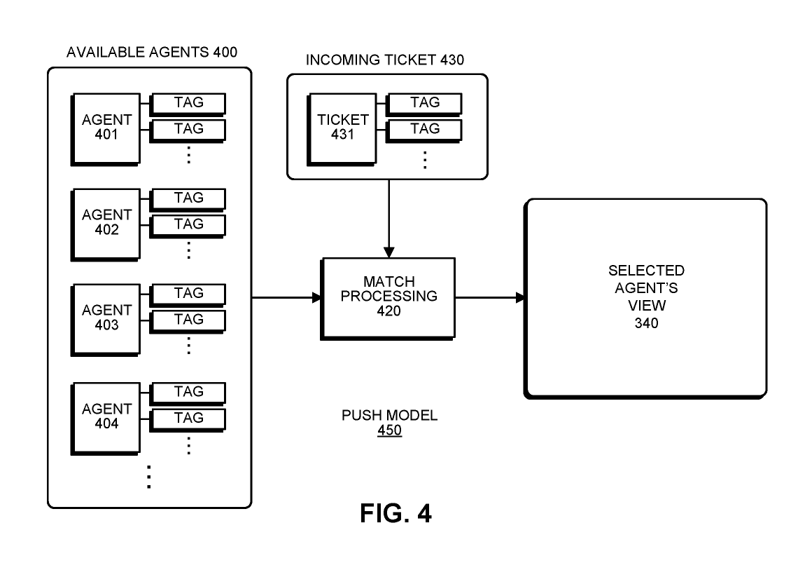

FIG. 4 illustrates the process for assigning tickets to agents under a push model in accordance with the disclosed embodiments. Before the process starts, the system has a set of available agents 400, wherein each agent is represented by a data structure, which includes tags that specify skills possessed by the agent. The process starts when the system receives an incoming ticket 430 to be processed at the customer-support ticketing system, wherein incoming ticket 430 is represented by a data structure 431, which is tagged with any required skills, which are required to respond to the ticket. Next, the system performs a match-processing operation 420 to select an agent from the set of available agents 400 to process the ticket. The system then presents the ticket to be processed to the agent through a view 440 in a UI for the agent, and then allows the agent to respond to the associated customer request. In general, the system may inform the agent about the new ticket in a number of ways, for example through an SMS message, a “growl” in a web UI, an email, or a private message in a social-networking site.

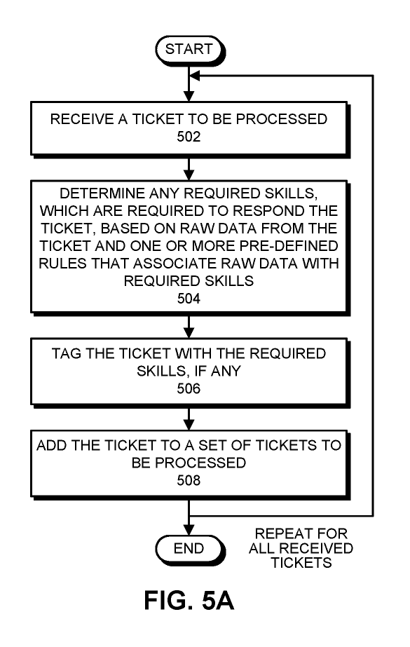

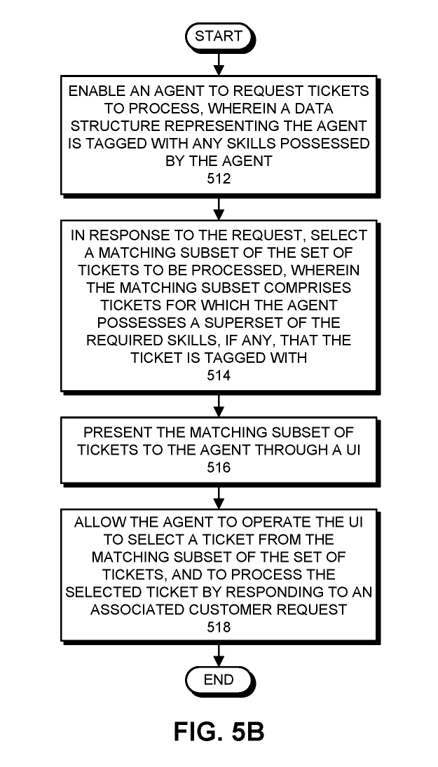

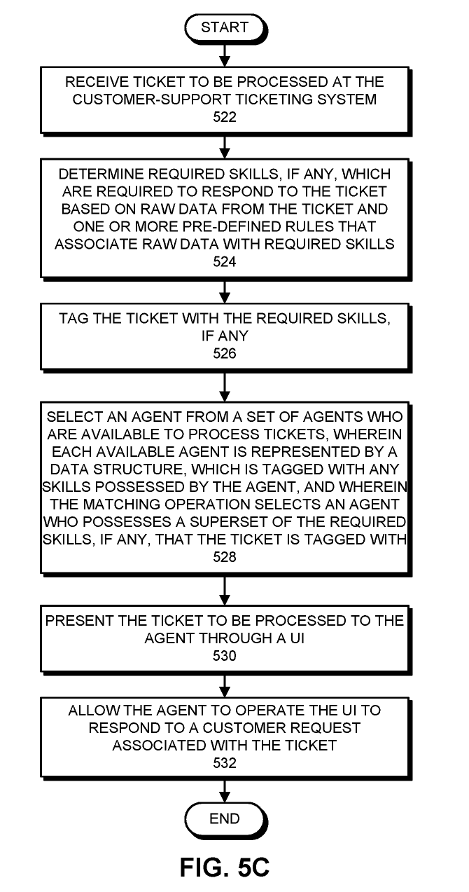

FIGS. 5A and 5B present flow charts illustrating a process for assigning tickets to agents in a customer-support ticketing system under a pull model in accordance with the disclosed embodiments. FIG. 5A illustrates how tickets are initially processed when they are received. First, the system receives a ticket to be processed (step 502). Next, the system determines any required skills, which are required to respond to the ticket based on raw data from the ticket and one or more pre-defined rules that associate raw data with required skills (step 504). The system then tags the ticket with the required skills, if any (step 506). Finally, the system adds the ticket to the set of tickets to be processed (step 508). This process is repeated for all incoming tickets.

Next, FIG. 5B illustrated how tickets are assigned to agents. First, the system enables an agent to request tickets to process, wherein a data structure representing the agent is tagged with any skills possessed by the agent (step 512). In response to the request, selects a matching subset of the set of tickets to be processed, wherein the matching subset comprises tickets for which the agent possesses a superset of the required skills that the ticket is tagged with (step 514). The system then presents the matching subset of tickets to the agent through a user interface (UI) (step 516), and allows the agent to operate the UI to select a ticket from the matching subset of the set of tickets to be processed; and process the selected ticket by responding to an associated customer request (step 518).

FIG. 5C presents a flow chart illustrating a process for assigning tickets to agents in a customer-support ticketing system under a push model in accordance with the disclosed embodiments. The system first receives a ticket to be processed at the customer-support ticketing system (step 522). Next, the system determines any required skills, which are required to respond to the ticket based on raw data from the ticket and one or more pre-defined rules that associate raw data with required skills (step 524). The system then tags the ticket with the required skills, if any (step 526). Next, the system performs a matching operation to select an agent from a set of agents who are available to process tickets, wherein each available agent is represented by a data structure, which is tagged with any skills possessed by the agent, and wherein the matching operation selects an agent who possesses a superset of the required skills, if any, that the ticket is tagged with (step 528). The system then presents the ticket to be processed to the agent through a UI (step 530), and allows the agent to operate the UI to process the ticket by responding to an associated customer request (step 532).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for associating tickets with agents in a customer-support ticketing system, comprising:
obtaining a set of tickets to be processed at the customer-support ticketing system, wherein each ticket is tagged with any required skills, which are required to respond to the ticket;
enabling an agent to request tickets to process, wherein a data structure representing the agent is tagged with any skills possessed by the agent;
in response to the request, selecting a matching subset of the set of tickets to be processed, wherein the matching subset comprises tickets for which the agent possesses a superset of the required skills that the ticket is tagged with;
presenting the matching subset of tickets to the agent through a UI; and
allowing the agent to operate the UI to,
select a ticket from the matching subset of the set of tickets to be processed, and
process the selected ticket by responding to an associated customer request.

2. The method of claim 1, wherein obtaining the set of tickets to be processed involves tagging each ticket in the set of tickets by:
determining any required skills, which are required to respond to the ticket based on raw data from the ticket and one or more pre-defined rules that associate raw data with required skills; and
tagging the ticket with the required skills, if any.

3. The method of claim 2, wherein the required skills for a ticket can include one or more of the following:
a language of the customer request;
a product or product line associated with the customer request;
a time zone associated with the customer request;
a level of technical skill required to respond to the customer request;
a level of emotional intelligence required to respond to the customer request;
a required agent tier for an agent who responds to the customer request; and
a required security level for an agent who responds to the customer request.

4. The method of claim 1, wherein in additional to being tagged with any required skills, each ticket in the set of tickets to be processed can be tagged with desired skills that the method attempts to match with an associated agent's skills.

5. The method of claim 1, wherein presenting the matching subset of tickets to the agent includes presenting the matching subset of tickets in an ordering based on how well the required skills of the tickets match the skills of the agent.

6. The method of claim 1, wherein the method further comprises allowing the agent to add, modify or remove tags for one or more skills from the data structure representing the agent.

7. The method of claim 1, wherein the method further comprises allowing the agent to add, modify or remove tags for one or more required skills from a ticket in the set of tickets to be processed.

8. A method for associating tickets with agents in a customer-support ticketing system, comprising:
receiving a ticket to be processed at the customer-support ticketing system, wherein the ticket is tagged with any required skills, which are required to respond to the ticket;
performing a matching operation to select an agent from a set of agents who are available to process tickets, wherein each available agent is represented by a data structure, which is tagged with any skills possessed by the agent, and wherein the matching operation selects an agent who possesses a superset of the required skills, if any, that the ticket is tagged with;
presenting the ticket to be processed to the agent through a user interface (UI); and
allowing the agent to operate the UI to process the ticket by responding to an associated customer request.

9. The method of claim 8, wherein receiving the ticket to be processed involves performing a tagging operation on the ticket by:
determining any required skills, which are required to respond to the ticket based on raw data from the ticket and one or more pre-defined rules that associate raw data with required skills; and
tagging the ticket with the required skills, if any.

10. The method of claim 9, wherein presenting the ticket to the agent through the UI includes presenting the ticket among a set of tickets to be processed by the agent, wherein tickets in the set of ticket are presented to the agent in an ordering based on how well the required skills of the tickets in the list match the skills of the agent.

11. The method of claim 9, wherein the required skills for a ticket can include one or more of the following:
a language of the customer request;
a product or product line associated with the customer request;
a time zone associated with the customer request;
a level of technical skill required to respond to the customer request;
a level of emotional intelligence required to respond to the customer request;
a required agent tier for an agent who responds to the customer request; and
a required security level for an agent who responds to the customer request.

12. The method of claim 8, wherein in additional to being tagged with required skills, the ticket can be tagged with desired skills that the method attempts to match with an agent's skills.

13. The method of claim 8, wherein presenting the ticket to be processed to the agent includes presenting the ticket to be processed to the agent among a set of tickets to be processed by the agent, wherein tickets in the set of ticket are presented to the agent in an ordering based on how well required skills of the tickets in the list match the skills of the agent.

14. The method of claim 8, wherein the method further comprises generating a ticket whenever a new customer request is received.

15. The method of claim 8, wherein the method further comprises allowing each agent to add, modify or remove tags for one or more skills from a data structure representing the agent.

16. The method of claim 8, wherein the method further comprises allowing each agent to add, modify or remove tags for one or more required skills from the ticket.

17. A non-transitory computer-readable storage medium storing instructions that when executed by a computer cause the computer to perform a method for associating tickets with agents in a customer-support ticketing system, the method comprising:
obtaining a set of tickets to be processed at the customer-support ticketing system, wherein each ticket is tagged with any required skills, which are required to respond to the ticket;
enabling an agent to request tickets to process, wherein a data structure representing the agent is tagged with any skills possessed by the agent;
in response to the request, selecting a matching subset of the set of tickets to be processed, wherein the matching subset comprises tickets for which the agent possesses a superset of the required skills that the ticket is tagged with;
presenting the matching subset of tickets to the agent through a UI;
presenting the matching subset of tickets to the agent through a UI; and
allowing the agent to operate the UI to,
select a ticket from the matching subset of the set of tickets to be processed, and
process the selected ticket by responding to an associated customer request.

18. The non-transitory computer-readable storage medium of claim 16, wherein obtaining the set of tickets to be processed involves tagging each ticket in the set of tickets by:
determining any required skills, which are required to respond to the ticket based on raw data from the ticket and one or more pre-defined rules that associate raw data with required skills; and
tagging the ticket with the required skills, if any.

19. The non-transitory computer-readable storage medium of claim 17, wherein the required skills for a ticket can include one or more of the following:
a language of the customer request;
a product or product line associated with the customer request;
a time zone associated with the customer request;
a level of technical skill required to respond to the customer request;
a level of emotional intelligence required to respond to the customer request;
a required agent tier for an agent who responds to the customer request; and
a required security level for an agent who responds to the customer request.

20. The non-transitory computer-readable storage medium of claim 17, wherein in additional to being tagged with any required skills, each ticket in the set of tickets to be processed can be tagged with desired skills that the method attempts to match with an associated agent's skills.

21. The non-transitory computer-readable storage medium of claim 17, wherein presenting the matching subset of tickets to the agent includes presenting the matching subset of tickets to the agent in an ordering based on how well the required skills of tickets match the skills of the agent.

22. The non-transitory computer-readable storage medium of claim 17, wherein the method further comprises allowing the agent to add, modify or remove tags for one or more skills from the data structure representing the agent.

23. The non-transitory computer-readable storage medium of claim 17, wherein the method further comprises allowing the agent to add, modify or remove tags for one or more required skills of a ticket in the set of tickets to be processed.

24. A non-transitory computer-readable storage medium storing instructions that when executed by a computer cause the computer to perform a method for associating tickets with agents in a customer-support ticketing system, comprising:
receiving a ticket to be processed at the customer-support ticketing system, wherein the ticket is tagged with any required skills, which are required to respond to the ticket;
perform a matching operation to select an agent from a set of agents who are available to process tickets, wherein each available agent is represented by a data structure, which is tagged with any skills possessed by the agent, and wherein the matching operation selects an agent who possesses a superset of the required skills, if any, that the ticket is tagged with;
presenting the ticket to be processed to the agent through a user interface (UI); and
allowing the agent to operate the UI to process the ticket by responding to an associated customer request.

25. The non-transitory computer-readable storage medium of claim 24,
wherein presenting the ticket to be processed to the agent includes presenting the ticket to the agent through a user interface (UI); and
wherein allowing the agent to process the ticket involves allowing the agent to operate the UI to respond to an associated customer request.

26. The non-transitory computer-readable storage medium of claim 25, wherein presenting the ticket to the agent through the UI includes presenting the ticket among a set of tickets to be processed by the agent, wherein tickets in the set of ticket are presented to the agent in an ordering based on how well the required skills of the tickets in the list match the skills of the agent.

27. The non-transitory computer-readable storage medium of claim 24, wherein the required skills for a ticket can include one or more of the following:
a language of the customer request;
a product or product line associated with the customer request;
a time zone associated with the customer request;
a level of technical skill required to respond to the customer request;
a level of emotional intelligence required to respond to the customer request;
a required agent tier for an agent who responds to the customer request; and
a required security level for an agent who responds to the customer request.

28. The non-transitory computer-readable storage medium of claim 24, wherein in additional to being tagged with any required skills, the ticket can be tagged with desired skills that the method attempts to match with an associated agent's skills.

29. The non-transitory computer-readable storage medium of claim 24, wherein presenting the ticket to be processed to the agent includes presenting the ticket to be processed to the agent among a set of tickets to be processed by the agent, wherein tickets in the set of ticket are presented to the agent in an ordering based on how well required skills of tickets in the list match the skills of the agent.

30. The non-transitory computer-readable storage medium of claim 24, wherein the method further comprises generating a ticket whenever a new customer request is received.

31. The non-transitory computer-readable storage medium of claim 24, wherein the method further comprises allowing each agent to add, modify or remove tags for one or more skills from the data structure representing the agent.

32. The non-transitory computer-readable storage medium of claim 24, wherein the method further comprises allowing each agent to add, modify or remove tags for one or more required skills from the ticket.

33. A system that associates tickets with agents in a customer-support ticketing system, comprising:
at least one processor and at least one associated memory; and
a processing mechanism that executes on the at least one processor, wherein during operation, the processing mechanism:
obtains a set of tickets to be processed at the customer-support ticketing system, wherein each ticket is tagged with any required skills, which are required to respond to the ticket;
enables an agent to request tickets to process, wherein a data structure representing the agent is tagged with any skills possessed by the agent;
in response to the request, selects a matching subset of the set of tickets to be processed, wherein the matching subset comprises tickets for which the agent possesses a superset of the required skills that the ticket is tagged with;
presenting the matching subset of tickets to the agent through a UI;
presents the matching subset of tickets to the agent through a UI; and
allows the agent to operate the UI to,
select a ticket from the matching subset of the set of tickets to be processed, and
process the selected ticket by responding to an associated customer request.

34. A system that associates tickets with agents in a customer-support ticketing system, comprising:
at least one processor and at least one associated memory; and
a processing mechanism that executes on the at least one processor, wherein during operation, the processing mechanism:
receives a ticket to be processed at the customer-support ticketing system, wherein the ticket is tagged with any required skills, which are required to respond to the ticket;
performs a matching operation to select an agent from a set of agents who are available to process tickets, wherein each available agent is represented by a data structure, which is tagged with any skills possessed by the agent, and wherein the matching operation selects an agent who possesses a superset of the required skills, if any, that the ticket is tagged with;
presents the ticket to be processed to the agent through a user interface (UI); and
allows the agent to operate the UI to process the ticket by responding to an associated customer request.
